(19) United States
(12) Patent Application Publication
(10) Pub. No.: US 2023/0334806 A1
(43) Pub. Date: Oct. 19, 2023

(54) SCALING NEURAL REPRESENTATIONS FOR MULTI-VIEW RECONSTRUCTION OF SCENES

(71) Applicant: Meta Platforms Technologies, LLC, Menlo Park, CA (US)

(72) Inventors: Lei XIAO, Redmond, WA (US); Derek NOWROUZEZAHRAI, Montreal (CA); Joey LITALIEN, Montreal (CA); Feng LIU, beaverton, OR (US)

(73) Assignee: Meta Platforms Technologies, LLC, Menlo Park, CA (US)

(21) Appl. No.: 18/123,058

(22) Filed: Mar. 17, 2023

Related U.S. Application Data
(60) Provisional application No. 63/330,406, filed on Apr. 13, 2022.

(51) Int. Cl. G06T 19/20; G06T 7/90; G06T 15/06; G06T 7/60; G06T 3/40; G06N 3/045

(52) U.S. Cl. CPC G06T 19/20; G06T 7/90; G06T 15/06; G06T 7/60; G06T 3/4046; G06N 3/045; G06T 2207/10024; G06T 2207/20084; G06T 2207/20081; G06T 2219/2012; G06T 2219/2016

(57) ABSTRACT

Neural representations may be used for multi-view reconstruction of scenes. A plurality of color images representing a scene from a plurality of camera poses may be received. For each point of a plurality of points along a ray, a signed distance and a color value may be determined as a function of a feature volume, a first neural network, and a second neural network. A predicted output color may be determined as a function of the density. At least one of the first neural network, the second neural network, the feature volume, or the transformation parameter may be adjusted based on the predicted output color and a corresponding target color obtained based on one of the color images. A three-dimensional representation of the scene may be displayed based on at least one of the first neural network, the second neural network, the feature volume, or the transformation parameter.

### PRIORITY

This patent application claims priority to U.S. Provisional Patent Application No. 63/330,406, entitled “Scaling Neural Representations for Multi-view Reconstruction of Scenes,” filed on Apr. 13, 2022.

### TECHNICAL FIELD

This patent application relates generally to image processing and reconstruction techniques, and more specifically, to systems and methods using scaling neural representations for multi-view reconstruction of scenes.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to form a first image and a second image, and with these images, to generate “binocular” vision for viewing by a user.

Providing quality reconstructed images for the user may, however, be challenging. For example, there are a number of hurdles associated with reconstructing of three-dimensional (3D) scenes from two-dimensional (2D) images.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIG. 3 illustrates a perspective view of a near-eye display in the form of a pair of glasses, according to an example.

FIG. 4 illustrates a block diagram of a scene reconstruction system to scale neural representations for multi-view reconstruction of scenes, in accordance with an example, according to an example.

FIG. 5 illustrates a diagram illustrating an example model implemented by a neural network module, according to an example.

FIG. 6 illustrates examples of neural radiance fields (NeRF)-based reconstruction.

FIG. 7 is a diagram illustrating an example cumulative distribution function of an example signed distance fields (SDF)-to-density transformation, according to an example.

FIG. 8 is a flow diagram illustrating an example method for using neural representations to reconstruct a three-dimensional (3D) scene based on multiple two-dimensional (2D) images, according to some examples.

FIG. 9 is a diagram illustrating an example camera setup and resulting predicted and target images resulting from an example training procedure, according to an example.

FIG. 10 is a diagram illustrating example results of the disclosed subject matter as compared with results obtained using other techniques, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Neural implicit three-dimensional (3D) representations may be used for surface reconstruction from input images. However, some neural implicit three-dimensional (3D) representations have limitations. Neural volume methods based on neural radiance fields (NeRF) may synthesize novel views. For example, given multiple views of a scene, techniques based on neural radiance fields may determine the appearance of the scene from a different point of view.

However, in some instances, neural radiance field (NeRF)-based techniques do not admit an accurate surface extraction mechanism, and may be characterized by severe geometric artifacts. Also, in other instances, surface-based methods, such as techniques based on neural signed distance fields (NSDFs), may more precisely model geometry relative to neural radiance field-based techniques. However, neural signed distance field (NSDF)-based techniques usually involve the use of foreground masks as supervision. Furthermore, hybrid techniques that combine the use of neural radiance fields (NeRF) and neural signed distance fields (NSDF) and unify volume and surface rendering may also be used to reconstruct 3D objects.

However, in some instances, such hybrid techniques may not be extended to scenes. In some examples, hybrid techniques typically assume that an object being reconstructed may be in the foreground to facilitate training and, as such, may not readily be adapted for closed, inside-out scenes. Initialization of the models used in these hybrid techniques typically involves initializing a geometry with a unit sphere, which may be an unsatisfactory fit for indoor rooms.

Disclosed herein are systems, methods, and apparatuses that may use neural three-dimensional (3D) representations for surface reconstruction from input two-dimensional (2D) images. In various examples, an implicit-explicit neural representation may jointly “learn” radiance and signed distance fields (SDFs). Various disclosed examples may use a learnable feature voxel grid, e.g., a feature volume, that may be shared between a geometry network and a shading network. In some examples, each voxel in the feature volume may spatially encode local information about a signed distance field (SDF), density, and color. In some examples, it may be appreciated that representing a scene using a feature volume may achieve a more compact memory footprint and higher quality three-dimensional (3D) reconstruction of the scene. As a result, in some examples, more efficient and practical scene capture pipelines for augmented reality (AR)/virtual reality (VR) applications may be realized.

According to various examples, neural representations may be used for multi-view reconstruction of scenes. In some examples, a method may include receiving a plurality of color images representing a scene from a plurality of camera positions or poses. In some examples, for each point of a plurality of points along a ray, a signed distance and a color value may be determined as a function of a feature volume, a first neural network, and a second neural network. Moreover, in some examples, a density may be determined as a function of the signed distance and a transformation parameter. Furthermore, in some examples, a predicted output color may be determined as a function of the (determined) density.

In some examples, at least one of the first neural network, a second neural network, a feature volume, or a transformation parameter may be adjusted based on the predicted output color and a corresponding target color that may be determined based on one of the color images. Also, in some examples, a three-dimensional (3D) representation of a scene may be displayed based on at least one of the first neural network, the second neural network, the feature volume, or the transformation parameter

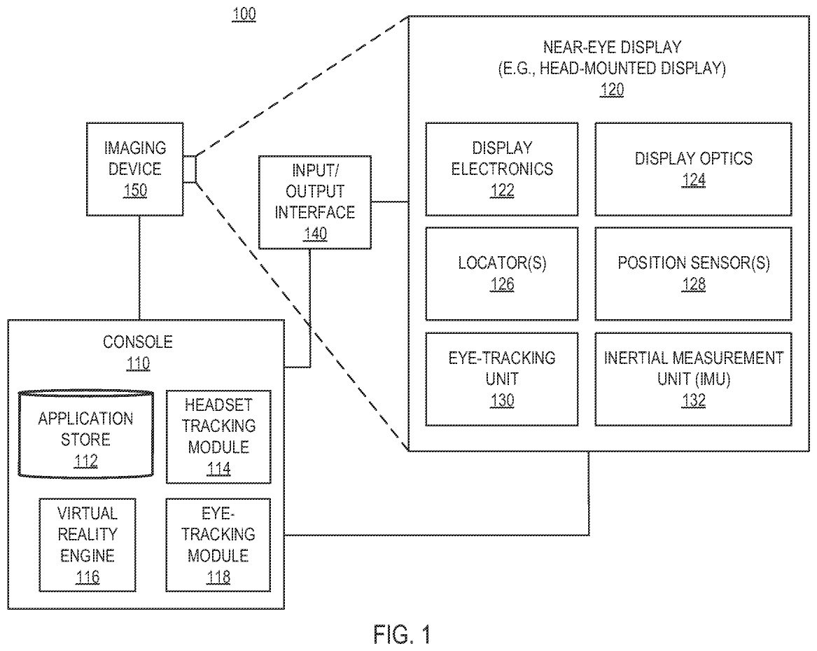

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eyebox, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head mounted display (HMD)) or both eyes (for binocular head mounted displays (HMDs)). Also, as used herein, an “eyebox” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eyebox.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

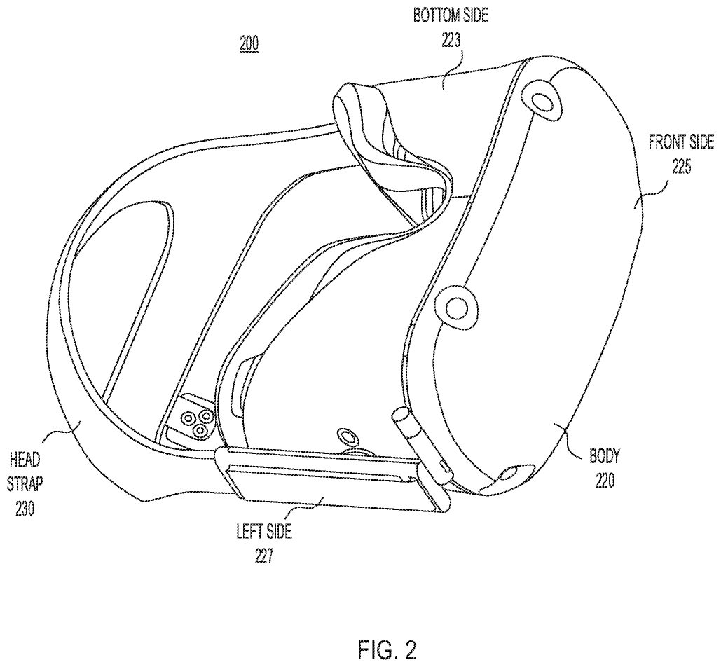

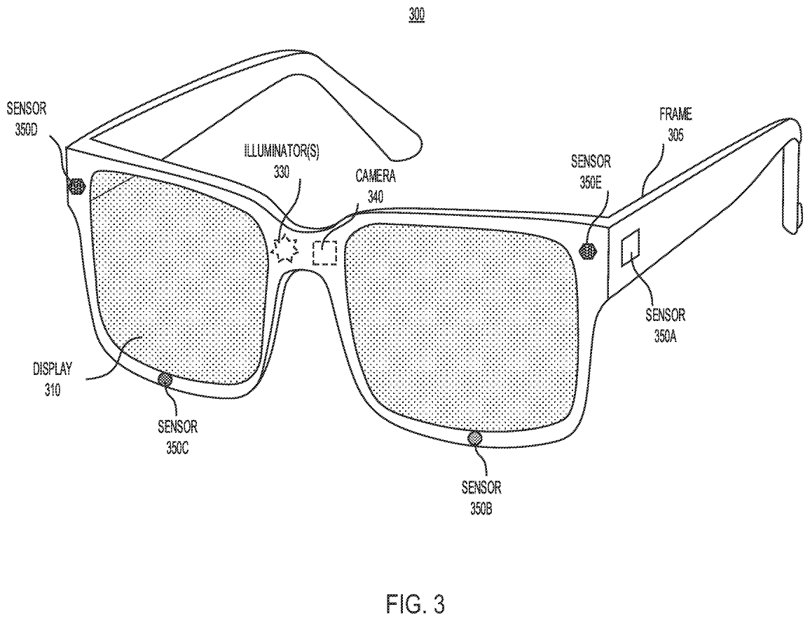

In some examples, the near-eye display 120 may be implemented in any suitable form-factor, including a head mounted display (HMD), a pair of glasses, or other similar wearable eyewear or device. Examples of the near-eye display 120 are further described below with respect to FIGS. 2 and 3. Additionally, in some examples, the functionality described herein may be used in a head mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye-tracking unit 130. In some examples, the near eye display 120 may also include one or more locators 126, one or more position sensors 128, and an inertial measurement unit (IMU) 132. In some examples, the near-eye display 120 may omit any of the eye-tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye-tracking unit 130 may include one or more eye-tracking systems. As used herein, “eye tracking” may refer to determining an eye's position or relative position, including orientation, location, and/or gaze of a user's eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye-tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye-tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye-tracking module 118. Based on the received information, the virtual reality engine 116 may determine content to provide to the near-eye display 120 for presentation to the user.

In some examples, the eye-tracking module 118 may receive eye-tracking data from the eye-tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye-tracking module 118 to more accurately determine the eye's orientation.

In some examples, a location of a projector of a display system may be adjusted to enable any number of design modifications. For example, in some instances, a projector may be located in front of a viewer's eye (e.g., “front-mounted” placement). In a front-mounted placement, in some examples, a projector of a display system may be located away from a user's eyes (e.g., “world-side”). In some examples, a head-mounted display (HMD) device may utilize a front-mounted placement to propagate light towards a user's eye(s) to project an image.

FIG. 2 illustrates a perspective view of a near-eye display in the form of a head-mounted display (HMD) device 200, according to an example. In some examples, the head mounted display (HMD) device 200 may be a part of a virtual reality (VR) system, an augmented reality (AR) system, a mixed reality (MR) system, another system that uses displays or wearables, or any combination thereof. In some examples, the head mounted display (HMD) device 200 may include a body 220 and a head strap 230. FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the head mounted display (HMD) device 200 for allowing a user to mount the head mounted display (HMD) device 200 onto the user's head. For example, the length of the head strap 230 may be adjustable to accommodate a range of user head sizes. In some examples, the head mounted display (HMD) device 200 may include additional, fewer, and/or different components.

In some examples, the head mounted display (HMD) device 200 may present, to a user, media or other digital content including virtual and/or augmented views of a physical, real-world environment with computer-generated elements. Examples of the media or digital content presented by the head mounted display (HMD) device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the head mounted display (HMD) device 200.

In some examples, the head mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head mounted display (HMD) device 200 may include an input/output interface 140 for communicating with a console 110, as described with respect to FIG. 1. In some examples, the head mounted display (HMD) device 200 may include a virtual reality engine (not shown), but similar to the virtual reality engine 116 described with respect to FIG. 1, that may execute applications within the head mounted display (HMD) device 200 and receive depth information, position information, acceleration information, velocity information, predicted future positions, or any combination thereof of the head mounted display (HMD) device 200 from the various sensors.

In some examples, the information received by the virtual reality engine 116 may be used for producing a signal (e.g., display instructions) to the one or more display assemblies. In some examples, the head mounted display (HMD) device 200 may include locators (not shown), but similar to the virtual locators 126 described in FIG. 1, which may be located in fixed positions on the body 220 of the head mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (e.g., “eye-side”). In some examples, and as discussed herein, a projector for a display system shaped liked eyeglasses may be mounted or positioned in a temple arm (e.g., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

FIG. 3 is a perspective view of a near-eye display 300 in the form of a pair of glasses (or other similar eyewear), according to an example. In some examples, the near-eye display 300 may be a specific example of near-eye display 120 of FIG. 1, and may be configured to operate as a virtual reality display, an augmented reality display, and/or a mixed reality display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc.

In some examples, the near-eye display 300 may further include various sensors 350a, 350b, 350c, 350d, and 350e on or within a frame 305. In some examples, the various sensors 350a-350e may include any number of depth sensors, motion sensors, position sensors, inertial sensors, and/or ambient light sensors, as shown. In some examples, the various sensors 350a-350e may include any number of image sensors configured to generate image data representing different fields of views in one or more different directions. In some examples, the various sensors 350a-350e may be used as input devices to control or influence the displayed content of the near-eye display 300, and/or to provide an interactive virtual reality (VR), augmented reality (AR), and/or mixed reality (MR) experience to a user of the near-eye display 300. In some examples, the various sensors 350a-350e may also be used for stereoscopic imaging or other similar application.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminator(s) 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications.

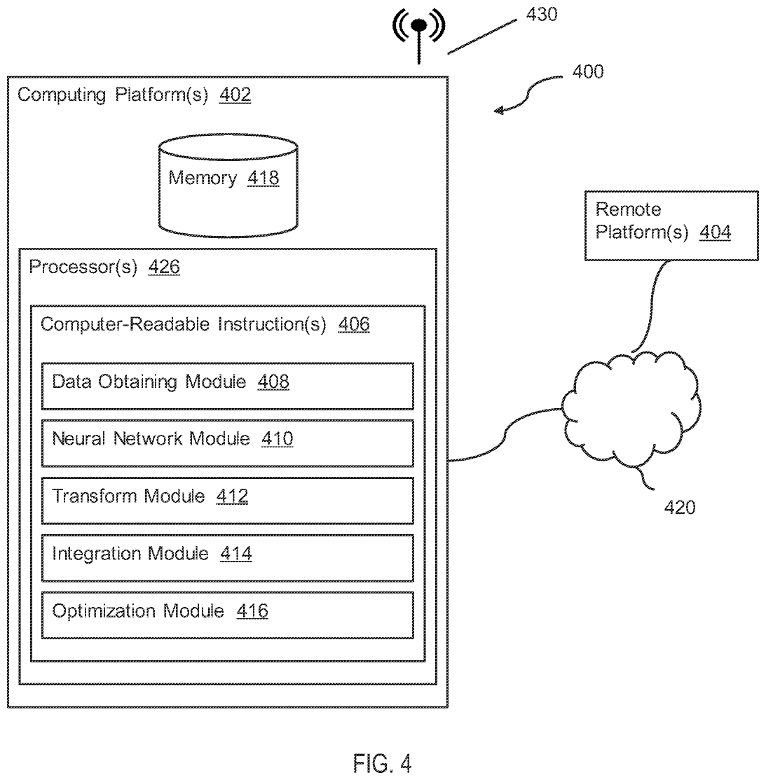

FIG. 4 illustrates a block diagram of a scene reconstruction system 400 to scale neural representations for multi-view reconstruction of scenes, in accordance with an example. The scene reconstruction system may include one or more computing platforms 402. The one or more computing platforms may be communicatively coupled with one or more remote platforms 404. In some examples, users may access the scene reconstruction system 400 via the remote platforms 404.

In some examples, the one or more computing platforms 402 may be configured by computer-readable instructions 406. In some instances, computer-readable instructions 406 may include modules. In some examples, the modules may be implemented as one or more of functional logic, hardware logic, electronic software modules, and the like. The modules may include one or more of a data obtaining module 408, a neural network module 410, a transform module 412, an integration module 414, and an optimization module 416.

In some examples, the data obtaining module 408 may receive a set of color images, e.g., monocular red, green, and blue (RGB) images, representing a scene. In some examples, the color images may correspond to known camera positions or poses.

In some examples, color images may be received from a memory 418. In particular, in some examples, the color images may be received from an imaging device, such as the imaging device 150 of FIG. 1 or the camera 340 of FIG. 3. Also, in some examples, the color images may be still images, and may be frames extracted from a video feed. As described herein, in some examples, the color images may be used to train one or more neural networks for reconstructing a 3D scene from the color images.

In some examples, the neural network module 410 may determine, for each point of a plurality of points along a ray, a signed distance and a color value as a function of a feature volume, a signed distance field (SDF) neural network, and a shading neural network. For example, the neural network module 410 may implement a plurality of neural networks that may represent a scene that is to be reconstructed.

In some cases, one or more computing platforms (e.g., the one or more computing platforms 402 of FIG. 4) may be communicatively coupled to a remote platform (e.g., the remote platform(s) 404). In some cases, the communicative coupling may include communicative coupling through a networked environment 420. In some examples, the networked environment 420 may include a radio access network, such as LTE or 5G, a local area network (LAN), a wide area network (WAN) such as the Internet, and/or wireless LAN (WLAN), for example. It may be appreciated that these examples are not intended to be limiting, and that the scope of this disclosure includes examples in which one or more computing platforms 402 and remote platform(s) 404 may be operatively linked via some other communication coupling.

In some examples, the one or more computing platforms 402 may be configured to communicate with the networked environment 420 via wireless or wired connections. In addition, in some examples, the one or more computing platforms 402 may be configured to communicate directly with each other via wireless or wired connections. Examples of one or more computing platforms 402 may include, but are not limited to, smartphones, wearable devices, tablets, laptop computers, desktop computers, Internet of Things (IoT) devices, and/or other mobile or stationary devices. In some examples, the system 400 may also include one or more hosts or servers, such as the one or more remote platforms 404 connected to the networked environment 420 through wireless or wired connections. In some examples, remote platforms 404 may be implemented in or function as base stations, which may also be referred to as Node Bs or evolved Node Bs (eNBs). In some examples, remote platforms 404 may include web servers, mail servers, application servers, etc. According to some examples, remote platforms 404 may be implemented as standalone servers, networked servers, or an array of servers.

In some examples, the one or more computing platforms 402 may include one or more processors 426 for processing information and executing instructions or operations. One or more processors 426 may be any type of general or specific purpose processor. In some cases, multiple processors 426 may be utilized. In some examples, the one or more processors 426 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as non-limiting examples. In some cases, the one or more processors 426 may be remote from the one or more computing platforms 402, such as disposed within a remote platform like the one or more remote platforms 404.

In some examples, the one or more processors 426 may perform functions associated with the operation of the system 400, which may include, for example, precoding of antenna gain/phase parameters, encoding and decoding of individual bits forming a communication message, formatting of information, and overall control of the one or more computing platforms 402, including processes related to management of communication resources.

In some examples, the one or more computing platforms 402 may further include or be coupled to the memory 418 (internal or external), which may be coupled to one or more processors 426, for storing information and instructions that may be executed by one or more processors 426. In some examples, memory 418 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 418 may include any combination of random access memory (RAM), read only memory (ROM), static storage such as a magnetic or optical disk, hard disk drive (HDD), or any other type of non-transitory machine or computer readable media. In some examples, the instructions stored in memory 418 may include program instructions or computer program code that, when executed by one or more processors 426, enable the one or more computing platforms 402 to perform tasks as described herein.

In some examples, one or more computing platforms 402 may also include or be coupled to one or more antennas 430 for transmitting and receiving signals and/or data to and from one or more computing platforms 402. In some examples, the one or more antennas 430 may be configured to communicate via, for example, a plurality of radio interfaces that may be coupled to the one or more antennas 430. Also, in some examples, the radio interfaces may correspond to a plurality of radio access technologies including one or more of LTE, 5G, WLAN, Bluetooth, near field communication (NFC), radio frequency identifier (RFID), ultrawideband (UWB), and the like. Furthermore, in some examples, the radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

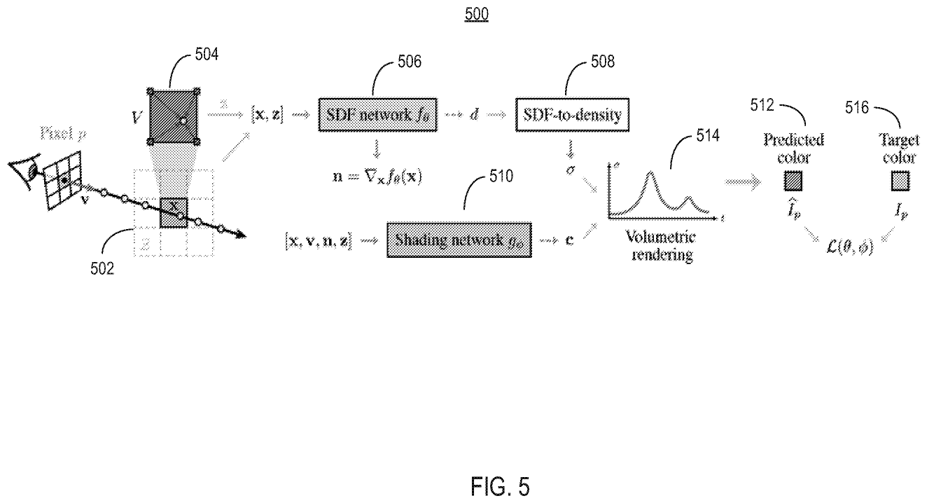

FIG. 5 is a diagram illustrating an example of a model 500 implemented by a neural network (e.g., the neural network module 410), according to an example. In the model 500, the scene may be represented using a hybrid surface-volume model that may be locally conditioned on a feature volume 502. In some examples, the feature volume 502 may comprise a plurality of volume elements, or voxels 504. Each voxel 504 may encode geometric and radiometric information of a small surface patch of the scene. Geometric information may include, among other things, the signed distance field (SDF), the surface normals, and density of the surface patch. In some instances, radiometric information may include a color of the surface patch.

In some examples, the neural network module 410 may compute, for each point x sampled along a ray r(t)=o+tv, t≥0 passing through a pixel p, an associated signed distance d and a color value c. Also, in some examples, a point in three-dimensional space may be queried into the feature volume 502, and may be decoded by a signed distance field (SDF) neural network 506 to produce a signed distance. Furthermore, in some examples, a transform module (e.g., the transform module 412 of FIG. 4) may transform the signed distance to a spatial density.

In some examples, a transform module (e.g., the transform module 412 of FIG. 4) may implement a signed distance field (SDF)-to-density converter 508. In some examples, a shading neural network 510 may produce a color value at the same point along the direction of a ray r(t).

In some examples, an integration module (e.g., the integration module 414 of FIG. 4) may integrate one or more points along a ray (e.g., for all values of t) using volumetric rendering to determine a predicted pixel color 512.

In some examples, the integration module 414 may implement a volumetric renderer 514. In some examples, with the radiance field modelled as a function of a signed distance field (SDF) neural network 506, the signed distance field (SDF) neural network 506, the shading neural network 510, and the feature volume 502 may be optimized jointly. For example, in some instances, an optimization module (e.g., the optimization module 416 of FIG. 4) may compare the predicted color 512 with a target color 516 (e.g., a corresponding target color), and may adjust one or more of the signed distance field (SDF) neural network 506, the shading neural network 510, the feature volume 502, and/or a transformation parameter used by the signed distance field (SDF)-to-density converter 508 based on the difference between the predicted color 512 and the target color 516. Accordingly, in some examples, a three-dimensional representation of the scene may be displayed based on at least one of the signed distance field (SDF) neural network, the shading neural network, the feature volume, or the transformation parameter.

In some examples, the feature volume 502, also denoted by Z, may be stored in an axis-aligned voxel grid that may span the bounding volume B=[−1,1]³, where each voxel 504, also denoted by V, in this regular voxel grid may include a learnable feature vector z_{V}^{(j)}∈ [symbol] ^{m} at each of its eight corners (indexed by j). The signed distance field (SDF) neural network 506 may be denoted by ƒ_{θ}, and the shading neural network 510 may be denoted by g_{ϕ}.

In some instances, to develop the model of the scene, a neural network module (e.g., the neural network module 410 of FIG. 4) may compute a signed distance for a query point x∈ [symbol] ³ along a ray by identifying the voxel V that contains x. In some examples, the neural network module 410 may then compute a per-voxel shape that embeds z(x; V)∈Z by tri-linearly interpolating the corner features of the voxel at x. In some examples, this embedding may be concatenated with the position, and may be provided to the signed distance field (SDF) neural network 506 to produce a signed distance d:

ƒ_{θ}([x,z])=d. (1)

In equation (1), f_{θ}([x, z]) may represent an output of the signed distance field (SDF) neural network 506 as a function of the query point x and the feature vector z and d may represent the signed distance.

In some examples, a signed distance field (SDF) may be a continuous function ƒ: [symbol] ³→ [symbol] such that d=f(x) may be a shortest distance from a point x∈ [symbol] ³ to a surface S=∂ [symbol] of a volume [symbol] ⊂ [symbol] ³, where the sign may indicate whether x may be inside or outside of [symbol] . In some examples, and according to convention, f>0 may be outside the volume, e.g., in free space, and f<0 may be inside the volume. Accordingly, the surface S may be represented by the zero level-set off:

S [symbol] {x∈ [symbol] ³|ƒ(x)≡0}. (2)

A well-defined signed distance field (SDF) may satisfy the Eikonal equation |∇ƒ|=1. A neural signed distance field (NSDF) may encode the field as the parameters θ of a neural network, which may be implemented as a multi-layer perceptron (MLP), ƒ_{θ}.

In some examples, a signed distance field (SDF) or a neural signed distance field (NSDF) may be rendered by performing ray-tracing along with a root-finding algorithm, such as sphere tracing. In some examples, a ray r emanating from a virtual camera located at x∈ [symbol] ³ with a unit view direction v∈ [symbol] ³ may be characterized by r(t)=x+tv, t≥0. In some examples, a surface point x_{surf}∈S may be obtained by iteratively marching toward the surface. In some examples, this may be done by querying the signed distance field (SDF) to compute a conservative stepping distance f(x)=d and then marching along the ray iteratively by that stepping distance: xₖ₊₁←xₖ+dv. Furthermore, in some examples, repeating this process may result in a surface hit after a finite number of steps k, assuming that the ray may intersect a surface.

In some examples, a geometry and an appearance of a scene may be learned from a collection of two-dimensional (2D) images by making a ray-surface interaction differentiable. That is, once x_{surf} may be obtained (e.g., when ƒ(x_{surf})≈0), the neural network module 410 may compute a color value based on its position and surface normal n=∇ₓƒ_{θ}/∥∇ₓƒ_{θ}∥, which may be determined via automatic differentiation. In some examples, for a neural signed distance field (NSDF), computing the color value may involve the shading neural network 510 mapping the position and normal to an red, green, and blue (RGB) color Îₚ at pixel p. In some examples, the signed distance field (SDF) neural network 506 and the shading neural network 510 may be optimized end-to-end from images using a pixel-wise loss, such as [symbol] (θ)=Eₚ∥Îₚ−Iₚ∥₂², where Iₚ may denote the ground-truth color at pixel p, e.g., the target color 516.

In some examples, a neural radiance field (NeRF) may be a continuous volumetric representation characterized as ƒ: [symbol] ⁶→ [symbol] ⁴ mapping a point x∈ [symbol] ³ and a view direction v∈ [symbol] ³ to an red, blue, and green (RGB) color c=(r, g, b) and a volumetric density σ≥0. In these examples, a neural radiance field is represented by a MLP ƒ_{θ}.

In some examples, a volumetric rendering technique may be used to render a neural radiance field. For example, for a ray r(t), an expected pixel color V) may be given by:

I(r)=∫₀^{+∞}T(t)σ(r(t))c(r(t))dt, (3)

where T(t) may represent an accumulated transmittance along the ray, σ may represent a volumetric density, and c may represent an red, green, and blue (RGB) color value:

T(t)=exp(∫₀^{t}σ(r(s))ds). (4)

For notational simplicity, in some instances, the dependency on p may be omitted. Also, in some examples, the transmittance may follow the Beer-Lambert law from physics and may represent a probability that the ray may travel a distance t without hitting any other particle. Accordingly, the opacity is represented by O(t)=1−T(t).

In some examples, the neural radiance field may be trained. For example, during optimization, equation (3) above may be approximated using a quadrature rule by taking random discrete samples {tᵢ}ᵢ₌₁^{N} ordered along each ray and accumulating transmittance, which may reduce to alpha compositing:

Î(r)=Σᵢ₌₁^{N}Tᵢ(1−exp(−σᵢδᵢ))cᵢ, (5)

Tᵢ=exp(−Σⱼ₌₁ⁱ⁻¹σⱼδⱼ), (6)

where Î(r) may represent the expected color value associated with a ray, σ may represent a volumetric density, δᵢ=tᵢ₊₁−tᵢ may represent a distance between adjacent samples, and c may represents an red, green, and blue (RGB) color value. In some examples, this operation may be naturally differentiable so that ƒ_{θ} may be optimized end-to-end similarly to the neural signed distance field (NSDF).

In some examples, to recover a surface, a mesh extraction algorithm, such as marching cubes, may be used to convert the learned density field into a triangle mesh based on a user-defined σ-threshold.

Also, in some examples, some neural signed distance field (NSDF) techniques may implicitly model geometric surfaces. However, in some examples, they may involve the use of foreground mask supervision in order to converge. Accordingly, in some examples, neural signed distance field (NSDF) techniques may focus on single object reconstruction with a clear foreground-background scene decomposition. In some examples, such methods may consider the first intersection points to keep the optimization tractable during sphere tracing. Accordingly, in some instances, abrupt depth changes may not be well captured under these frameworks, and incorrect reconstruction for highly nonconvex shapes or occluded regions may occur as a result.

On the other hand, in some examples, neural radiance field-based techniques may produce novel view synthesis without masks. Neural radiance field-based techniques, however, may be inherently volumetric, e.g., their true geometric meaning may be ambiguous. In some examples, a density threshold may be specified on a per-scene basis to extract meaningful geometry, which may lead to noisy and/or inaccurate reconstruction with severe artifacts.

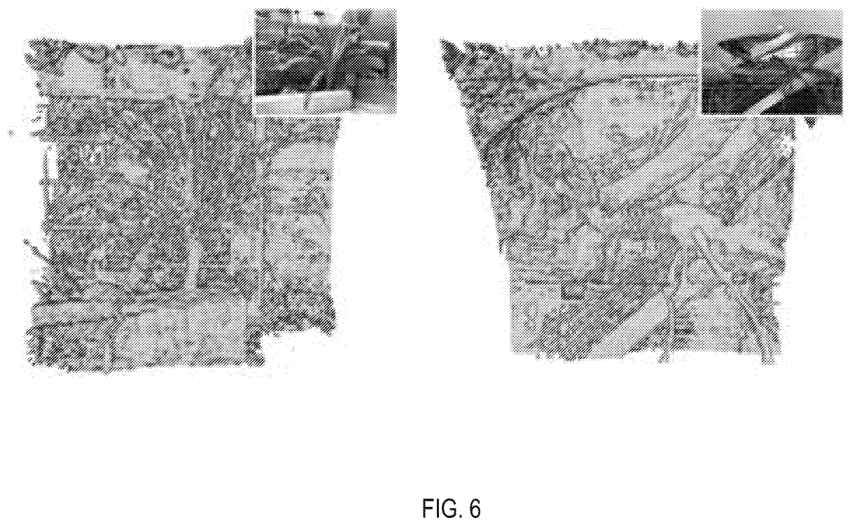

FIG. 6 illustrates examples of shortcomings of neural radiance field-based reconstruction techniques. As shown in FIG. 6, in some examples, extracting a surface using marching cubes may produce inaccurate geometry with perspective or floating artifacts that may not represent a true geometry of a scene.

In some instances, some neural radiance field (NeRF)-based techniques may target single object reconstruction with a front-facing camera setup. In some examples, various scene parameterizations may be used to mitigate this issue when a clear inside-outside semantic separation of the scene may be available. However, indoor scenes may often not be characterized by a clear inside-outside semantic separation, and thus may be difficult to reconstruct using such scene parameterizations.

Some hybrid representations may use a combination of neural radiance field (NeRF)-based techniques and neural signed distance field (NSDF)-based techniques. In some examples, implicit surface models and radiance fields may be formulated in a unified manner, thereby enabling surface rendering and volumetric rendering within the same rendering framework. In some examples, this “unified” perspective may facilitate a design of more accurate surface reconstruction pipelines without use of foreground masks. For example, in some instances, a volume density may be modelled as a function of the geometry. Moreover, in some examples, a sampling routine may be used to bound an error on an opacity approximation. In other examples, a density distribution may be induced by a signed distance field (SDF). Also, in some examples, volumetric rendering may be used to fuse volumetric representations associated with neural radiance field (NeRF)-based techniques and surface representations associated with neural signed distance field (NSDF)-based techniques. A hybrid representation may simultaneously encode a scene as a volume and may provide a conversion between the signed distance field (SDF) and density. As another example, depth measurements may be incorporated into the radiance field formulation. In some examples, a truncated signed distance field (SDF) may be used to bridge the respective frameworks of neural radiance field-based techniques and neural signed distance field (NSDF)-based techniques. As another example, surface reconstruction may be improved by shrinking the sample region of volume rendering during optimization.

In some instances, techniques using hybrid representations may be used for reconstructing single objects. In some examples, such techniques, however, may not be suitable for reconstructing large scale environments, such as indoor scenes. Some techniques may assume that an object may be in the foreground to facilitate training and may not be readily adapted for closed, inside-out scenes. For example, initialization of these models may involve initializing a geometry with a unit sphere that may not fit indoor rooms. Various examples described herein may scale hybrid representations for use in reconstructing indoor environments.

In some examples, a pseudo-distance normal n may be determined as n=∇ₓƒ_{θ}/∥∇ₓƒ_{θ}∥. In some examples, to produce a color c(x, v) attached to the ray point (x, v), the neural network module 410 may concatenate the position x, the input view direction v, the surface normal n, and the same encoding z and provide the resulting vector to the shading neural network g_{ϕ}:

g_{φ}([x,v,n,z])=c(x,v). (7)

Accordingly, in some examples, the encoding z simultaneously encodes geometric and shading information.

In some examples, after a neural network module (e.g., the neural network module 410 of FIG. 4) may compute the signed distance for the query point x∈ [symbol] ³, a transform module (e.g., the transform module 412 of FIG. 4) may transform the signed distance field (SDF) to a density value α for volumetric integration. A transform module (e.g., the transform module 412 of FIG. 4) may implement a signed distance field (SDF)-to-density converter (e.g., the signed distance field (SDF)-to-density convertor 508 of FIG. 5) and may use a parameterization, e.g.:

$$σ ( x ) = \frac{1}{β} {Ψ}_{β} ( - d ) , \qquad ( 8 )$$

where σ(x) may represent a density as a function of a query point x, β>0 may represent a learnable global parameter, d may represent a signed distance, and Ψ may represent a cumulative distribution function (CDF) of a Laplace distribution with zero mean and scale β defined as:

$${Ψ}_{β} ( τ ) \{ \begin{matrix}\frac{1}{2} exp ( \frac{τ}{β} ) , & if τ \leq 0 \\ 1 - \frac{1}{2} exp ( - \frac{τ}{β} ) , & if τ > 0\end{matrix} \qquad ( 9 )$$

where τ represents the input to the function Ψ, e.g., the decoded signed distance field (SDF) value. In some examples, the function Ψ may map signed distance field (SDF) values to density values.

In some instances, this density may model a homogeneous solid object with a constant density β⁻¹ that may smoothly decrease toward its boundary, where the rate of decrease may be controlled by β. So, in some examples, when β→0, it may be seen from equation (8) that σ→β⁻¹1 [symbol] for all nonboundary points x∈ [symbol] \S.

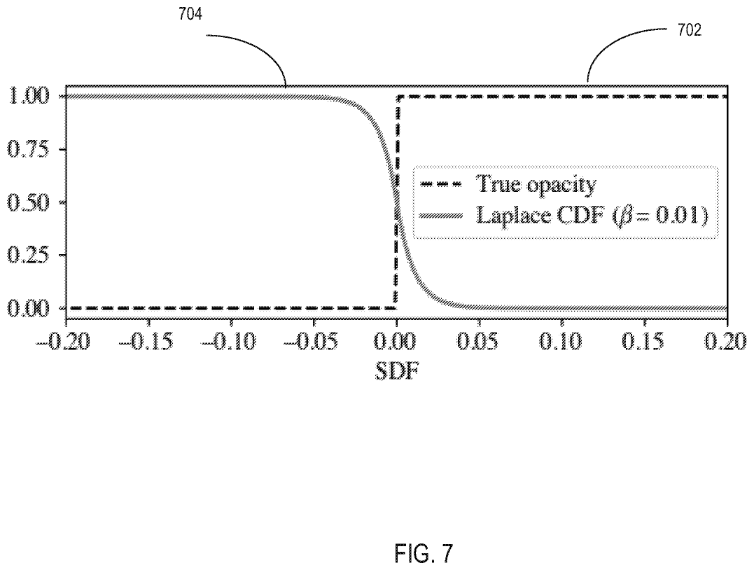

FIG. 7 is a diagram illustrating an example cumulative distribution function of an example signed distance fields (SDF)-to-density transformation, according to an example. In some examples, the parameter β may be learned during optimization. FIG. 7 illustrates a signed distance field (SDF) on the horizontal axis and a cumulative distribution function on the vertical axis. In some examples, true opacity may be represented by a curve 702. Also, in some examples, a curve resulting from a cumulative distribution function with a scale β=0.01 may be represented by a curve 704.

In some examples, after the signed distance field (SDF) may be converted to a density σ, an integration module (e.g., the integration module 414 of FIG. 4) may determine a predicted output color as a function of the density σ. Also, in some examples, the integration module 414 may implement a volumetric renderer (e.g., the volumetric renderer 514 of FIG. 5). In some examples, the integration module may apply equations (5) and (6) disclosed herein to determine the predicted pixel color Îₚ.

In some examples, a model (e.g., the model 500 of FIG. 5) may be initialized by pre-training a feature volume (e.g., the feature volume 502 of FIG. 5) and a signed distance field (SDF) neural network (e.g., the signed distance field (SDF) neural network 506 of FIG. 5) to approximate an inside-out cube enclosed in the bounding box B. In some examples, the feature vector zᵥ∈Z may be initialized with a Gaussian prior with a zero mean and σ=0.01. In some examples, the model may be pre-trained for a duration, e.g., 25 epochs.

In some examples, a stratified sampling approach may be used to sample points along rays. So, in some examples, samples may be constrained to lie within the bounding box B. In some examples, for a given ray r(t), a value tₘₐₓ may be determined such that r(tₘₐₓ) lies on the boundary of the bounding box B. Also, in some examples, N_{c} samples may be distributed in the interval [0, tₘₐₓ]. In some instances, hierarchical sampling may be used to draw an additional N_{f} samples and to produce more concentrated samples near surfaces. Furthermore, in some examples, because the camera may be assumed to be inside the scene bounding volume, all sampled points are contained in the scene bounding volume. In an example, N_{c} may be set to 128 and N_{f} may be set to 64.

In some examples, an optimization module (e.g., the optimization module 416 of FIG. 4) may adjust at least one of a signed distance field (SDF) neural network (e.g., the signed distance field (SDF) neural network 506 of FIG. 5), a shading neural network (e.g., the shading neural network 510 of FIG. 5), a feature volume (e.g., the feature volume 502 of FIG. 5), or the transformation parameter β based on the predicted pixel color Îₚ and a corresponding target color Iₚ that may be determined based on one of the color images. In some examples, this adjustment may be performed based on a loss function. In some examples, the loss function may be defined as a sum of three terms:

[symbol]

(θ,ϕ) [symbol] [symbol] _{RGB}(θ,ϕ)+λ [symbol] _{SDF}(θ)+ρ [symbol] _{Reg}(θ), (10)

where

[symbol]

_{RGB}(θ,ϕ)=Eₚ∥Îₚ−Iₚ∥₁ (11)

[symbol]

_{SDF}(θ)=E_{y}(∥∇_{y}ƒ_{θ}(y)∥₂−1)² (12)

[symbol]

_{Reg}(θ)=E_{y′}(π(ƒ_{θ}(y_{far}′))+π(−ƒ_{θ}(yₙₑₐᵣ′))). (13)

In equation (13), π may represent a rectified linear unit (ReLU). [symbol] _{RGB} may represent a photo-consistency loss term to ensure correct red, green, and blue (RGB) predictions for novel view synthesis. [symbol] _{SDF} may represent an Eikonal loss that may regularize the signed distance field (SDF), where an expectation may be estimated by equally combining N=N_{c}+N_{f} uniformly distributed points in the bounding box B and N ray samples. [symbol] _{Reg} may represent an additional regularization term that may force the ray endpoints to be either unoccluded or occluded. For example, in some instances, the first three points yₙₑₐᵣ′ along a ray may be regularized to have a positive signed distance field (SDF) value, indicating that the points are located in free space. Also, for example, the last sample point y_{far}′ along a ray may be regularized to have a negative signed distance field (SDF) value, indicating that the point is located inside the surface. In some examples, the use of the [symbol] _{Reg} regularization term may facilitate reconstructing the walls of indoor scenes by reducing the number of holes that appear in the reconstructed scene. The values λ and ρ may be hyperparameters that may be set to, for example, λ=1.0 and ρ=0.5.

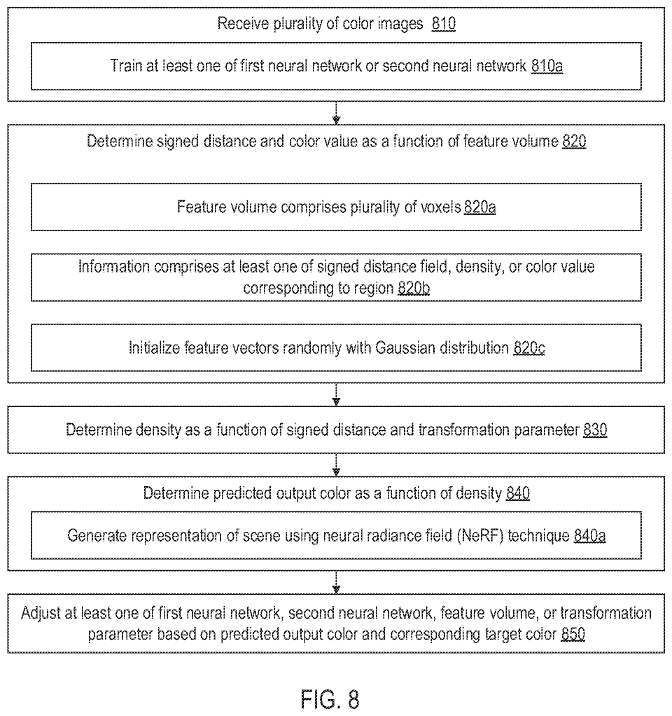

FIG. 8 is a flow diagram illustrating an example method 800 for using neural representations to reconstruct a three-dimensional (3D) scene based on multiple two-dimensional (2D) images, according to various examples. In various examples, the method 800 may be performed by a device (e.g., the scene reconstruction system 400 of FIG. 4). In some examples, the method 800 is performed by processing logic, including hardware, firmware, software, or a combination thereof. In some examples, the method 800 may be performed by a processor executing code stored in a non-transitory computer-readable medium (e.g., a memory). Briefly, in various examples, the method 800 may include receiving a plurality of color images representing a scene from a plurality of camera poses. In some examples, for each point of a plurality of points along a ray, a signed distance and a color value may be determined as a function of a feature volume comprising a plurality of voxels, a first neural network, and a second neural network. In some examples, a density may be determined as a function of the signed distance and a transformation parameter. Also, in some examples, a predicted output color may be determined as a function of the density. In some examples, at least one of the first neural network, the second neural network, the feature volume, or the transformation parameter may be adjusted based on the predicted output color and a corresponding target color that may be determined based on one of the color images. In some examples, a three-dimensional representation of the scene may be displayed based on at least one of the first neural network, the second neural network, the feature volume, or the transformation parameter.

As represented by block 810, in various examples, the method 800 may include receiving a plurality of color images representing a scene from a plurality of camera poses. For example, a camera or other imaging device may be used to capture monocular red, green, and blue (RGB) images representing the scene. The color images may correspond to known camera positions or poses. In some examples, the color images may be received from a memory. The color images may be still images. The color images may be frames extracted from a video feed. In some examples, as represented by block 810a, at least one of the first neural network or the second neural network may be trained using the plurality of color images. For example, the first neural network may be implemented as a signed distance field (SDF) neural network, and the second neural network may be implemented as a shading neural network. In some examples, the color images may be used to determine target colors for comparing with predicted color values to optimize the signed distance field (SDF) neural network and/or the shading neural network.

As represented by block 820, in various examples, the method 800 may include determining, for each point of a plurality of points along a ray, a signed distance and a color value as a function of a feature volume comprising a plurality of voxels, a first neural network, and a second neural network. For example, for a given query point x∈ [symbol] ³ along a ray, the signed distance may be determined by identifying the voxel V that contains x. In some examples, the neural network module 410 may then compute a per-voxel shape that embeds z(x; V)∈Z by trilinearly interpolating the corner features of the voxel at x. In some examples, this embedding may be concatenated with the position, and may be provided to the signed distance field (SDF) neural network to produce the signed distance d using equation (1) disclosed herein: ƒ_{θ}([x,z])=d.

In some examples, as represented by block 820a, the feature volume may comprise a plurality of voxels. In some examples, each voxel may comprise a plurality of feature vectors that may comprise information relating to a region of the scene, such as a surface patch. In some examples, this information may include geometric and radiometric information of the region. In some examples, as represented by block 820b, the information may comprise at least one of a signed distance field (SDF), a density, or a color value corresponding to the region.

In some examples, as represented by block 820c, feature vectors may be initialized randomly, e.g., with a Gaussian distribution. For example, the feature vectors zᵥ∈Z may be initialized with a Gaussian distribution prior with a zero mean and σ=0.01. In some examples, the model may be pre-trained for a duration, e.g., 25 epochs.

As represented by block 830, in various examples, the method 800 may include determining a density as a function of the signed distance and a transformation parameter. For example, the transform module 412 of FIG. 4 may use a cumulative distribution function (CDF) with a parameterization to determine the density,

$$e . g . , σ ( x ) = \frac{1}{β} {Ψ}_{β} ( - d ) ,$$

where β>0 is a learnable global parameter and Ψ is the cumulative distribution function (CDF) of the Laplace distribution with zero mean and scale β defined as:

$${Ψ}_{β} ( τ ) \{ \begin{matrix}\frac{1}{2} exp ( \frac{τ}{β} ) , & if τ \leq 0 \\ 1 - \frac{1}{2} exp ( - \frac{τ}{β} ) , & if τ > 0\end{matrix} \qquad ( 9 )$$

where τ may represent the input to the function Ψ, e.g., the decoded signed distance field value. The function Ψ may map signed distance field (SDF) values to density values.

In some examples, this density may model a homogeneous solid object with a constant density β⁻¹ that may smoothly decrease toward its boundary, where the rate may be controlled by β. When β→0, it may be seen that σ→δ⁻¹1 [symbol] for all nonboundary points x∈ [symbol] \S.

As represented by block 840, in various examples, the method 800 may include determining a predicted output color as a function of the density. In some examples, the integration module 414 may apply equations (5) and (6) disclosed herein to determine the predicted output color.

In some examples, as represented by block 840a, a representation of the scene may be generated using a neural radiance field (NeRF) technique. In some examples, a volumetric rendering technique may be used to render a neural radiance field. For example, for a ray r(t), an expected pixel color I(r) may be given by: I(r)=∫₀^{+∞}T(t)σ(r(t))c(r(t))dt, where T(t) may represent the accumulated transmittance along the ray: T(t)=exp(∫₀^{t}σ(r(s))ds). In some instances, for notational simplicity, the dependency on p may be omitted. Furthermore, in some examples, the transmittance may follow the Beer-Lambert law from physics and may represent the probability that the ray travels a distance t without hitting any other particle. Accordingly, the opacity may be represented by O(t)=1−T(t).

In some examples, the neural radiance field may be trained. During optimization, in some examples, equation (3) as disclosed herein may be approximated using a quadrature rule by taking random discrete samples {tᵢ}ᵢ₌₁^{N} ordered along each ray and accumulating transmittance, which reduces to alpha compositing:

Î(r)=Σᵢ₌₁^{N}Tᵢ(1−exp(−σᵢδᵢ))cᵢ,

Tᵢ=exp(−Σⱼ₌₁ⁱ⁻¹σⱼδⱼ),

where δᵢ=tᵢ₊₁−tᵢ may be the distance between adjacent samples. This operation may be naturally differentiable so that ƒ_{θ} may be optimized end-to-end similarly to the neural signed distance field (NSDF). To recover a surface, a mesh extraction algorithm, such as marching cubes, may be used to convert the learned density field into a triangle mesh based on a user-defined σ-threshold.

As represented by block 850, in various examples, the method 800 may include adjusting at least one of the first neural network, the second neural network, the feature volume, or the transformation parameter based on the predicted output color and a corresponding target color determined based on one of the color images. In some examples, this adjustment may be performed based on a loss function. Also, in some examples, the loss function may be defined as a sum of three terms: [symbol] (θ, ϕ) [symbol] [symbol] _{RGB}(θ,ϕ)+λ [symbol] _{SDF}(θ)+ρ [symbol] _{Reg}(θ),

where

[symbol]

_{RGB}(θ,ϕ)=Eₚ∥Îₚ−Iₚ∥₁

[symbol]

_{SDF}(θ)=E_{y}(∥∇_{y}ƒ_{θ}(y)∥₂−1)²

[symbol]

_{Reg}(θ)=E_{y′}(π(ƒ_{θ}(y_{far}′))+π(−ƒ_{θ}(yₙₑₐᵣ′))).

In the above equation, π may represent a rectified linear unit (ReLU). [symbol] _{RGB} may represent a photo-consistency loss term to ensure correct red, green, and blue (RGB) predictions for novel view synthesis. [symbol] _{SDF} may represent an Eikonal loss to regularize the signed distance field (SDF), where the expectation may be estimated by equally combining N=N_{c}+N_{f} uniformly distributed points in the bounding box B and N ray samples. In some examples, [symbol] _{Reg} may represent an additional regularization term that may force the ray endpoints to be either unoccluded or occluded. For example, the first three points yₙₑₐᵣ′ along a ray may be regularized to have a positive signed distance field (SDF) value, indicating that the points are located in free space. Also, for example, the last sample points y_{far}′ along a ray may be regularized to have a negative signed distance field (SDF) value, indicating that the points are located inside the surface. Furthermore, in some examples, the use of the [symbol] _{Reg} regularization term may facilitate reconstructing the walls of indoor scenes by reducing the number of holes that appear in the reconstructed scene. In some examples, the values λ and ρ may be hyperparameters that may be set to, for example, λ=1.0 and ρ=0.5.

In some instances, the reconstruction capabilities of the disclosed subject matter may be tested on a synthetic indoor scene. In some examples, the feature grid that may be used to test the reconstruction capabilities of the disclosed subject matter may have had a resolution of 323, and each feature vector had a dimension m=32. In some examples, the signed distance field (SDF) neural network and the shading neural network were implemented as four-layer multilayer perceptrons (MLPs) with hidden dimension h=128 with rectified linear unit activations in the intermediate layers. In some examples, before the signed distance field (SDF)-to-density conversion, the output signed distance field (SDF) d may be rescaled to fit the range of the bounding box B as d [symbol] |B| tan h(d), where |B| [symbol] 2\sqrt{3} may denote the bounding box diagonal length. In some examples, restricting this range slightly improved stability early in training. Also, in some examples, the shading neural network may have had a sigmoid output activation for red, green, and blue (RGB), and the signed distance field (SDF)-to-density global parameter may be initialized as β=0.1.

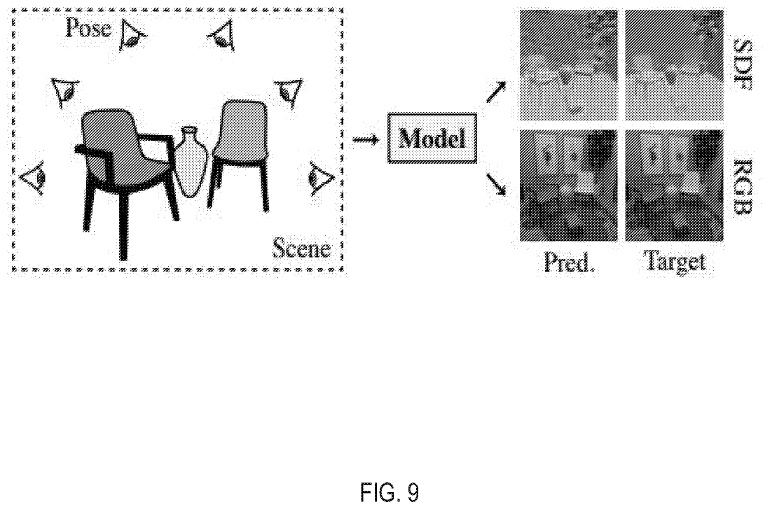

In some examples, the disclosed subject matter may be implemented in PyTorch. Each scene may be trained for 200 epochs using an optimizer with a learning rate of 5×10⁻⁴ and a batch size of 1024 pixels p. In some examples, training may take approximately two days on an NVIDIA V100 graphics processing unit. FIG. 9 is a diagram illustrating an example camera setup and resulting predicted and target images resulting from an example training procedure, according to an example.

In some examples, a dataset may include a collection of posed images with known camera intrinsic and extrinsic parameters rendered from a synthetic scene. In some examples, the dataset may be generated using Blender and objects and materials available in BlenderKit. In some examples, a number (e.g., M=128) of camera poses may be generated using a hemispherical dome contained within the scene bounds and pointing toward the origin. The images were rendered at a resolution of 512×512. In some examples, a single training epoch may exhibit approximately 33 million rays.

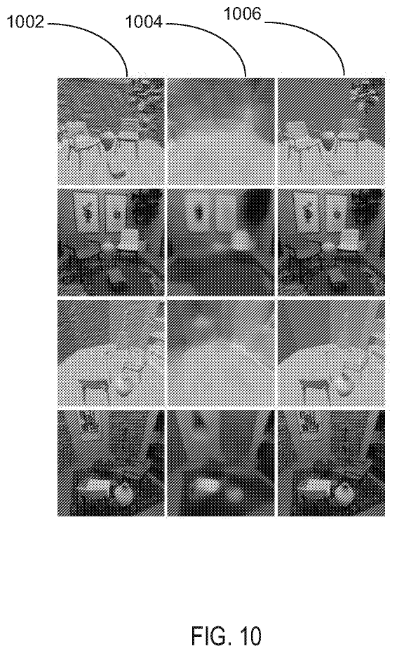

FIG. 10 illustrates example results 1002 of the disclosed subject matter as compared with results 1004 obtained using other techniques, according to an example. In some examples, the disclosed subject matter reconstructed most of the objects in the scene. Accordingly, in some examples, it may be that the combination of a feature volume and smaller multilayer perceptron (MLP) decoders may facilitate large scene reconstruction because it may allow the model to locally use and spread its capacity on different regions of the scene during optimization.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A system, comprising:
a processor; and
a memory storing processor-executable instructions that, when executed by the processor, cause the processor to:
receive a plurality of color images representing a scene from a plurality of camera poses;
determine, for each point of a plurality of points along a ray, a signed distance and a color value as a function of a feature volume comprising a plurality of voxels, a first neural network, and a second neural network;
determine a density as a function of the signed distance and a transformation parameter;
determine a predicted output color as a function of the density;
adjust at least one of the first neural network, the second neural network, the feature volume, or the transformation parameter based on the predicted output color and a corresponding target color determined based on one of the color images; and
display a three-dimensional representation of the scene based on at least one of the first neural network, the second neural network, or the transformation parameter.

2. The system of claim 1, wherein the processor-executable instructions further cause the processor to train at least one of the first neural network or the second neural network using the plurality of color images.

3. The system of claim 1, wherein each voxel comprises a plurality of feature vectors comprising information relating to a region of the scene.

4. The system of claim 3, wherein the information comprises at least one of a signed distance field (SDF), a density, or a color value corresponding to the region.

5. The system of claim 3, wherein the processor-executable instructions further cause the processor to initialize the feature vectors randomly with a Gaussian distribution.

6. The system of claim 1, wherein the processor-executable instructions further cause the processor to generate a representation of the scene using a neural radiance field (NeRF) technique.

7. The system of claim 1, wherein the first neural network comprises a signed distance field (SDF) neural network and the second neural network comprises a shading neural network.

8. A method, comprising:
obtaining a plurality of color images representing a scene from a plurality of camera poses;
determining, for each point of a plurality of points along a ray, a signed distance and a color value as a function of a feature volume comprising a plurality of voxels, a first neural network, and a second neural network;
determining a density as a function of the signed distance and a transformation parameter;
determining a predicted output color as a function of the density;
adjusting at least one of the first neural network, the second neural network, the feature volume, or the transformation parameter based on the predicted output color and a corresponding target color obtained based on one of the color images; and
displaying a three-dimensional representation of the scene based on at least one of the first neural network, the second neural network, the feature volume, or the transformation parameter.

9. The method of claim 8, further comprising training at least one of the first neural network or the second neural network using the plurality of color images.

10. The method of claim 8, wherein each voxel comprises a plurality of feature vectors comprising information relating to a region of the scene.

11. The method of claim 10, wherein the information comprises at least one of a signed distance field (SDF), a density, or a color value corresponding to the region.

12. The method of claim 10, further comprising initializing the feature vectors randomly with a Gaussian distribution.

13. The method of claim 10, further comprising generating a representation of the scene using a neural radiance field (NeRF) technique.

14. A non-transitory computer readable storage medium comprising an executable that, when executed, instructs a processor to:
receive a plurality of color images representing a scene from a plurality of camera poses;
determine, for each point of a plurality of points along a ray, a signed distance and a color value as a function of a feature volume comprising a plurality of voxels, a first neural network, and a second neural network;
determine a density as a function of the signed distance and a transformation parameter;
determine a predicted output color as a function of the density;
adjust at least one of the first neural network, the second neural network, the feature volume, or the transformation parameter based on the predicted output color and a corresponding target color determined based on one of the color images; and
display a three-dimensional representation of the scene based on at least one of the first neural network, the second neural network, the feature volume, or the transformation parameter.

15. The non-transitory computer readable storage medium of claim 14, wherein the executable further causes the processor to train at least one of the first neural network or the second neural network using the plurality of color images.

16. The non-transitory computer readable storage medium of claim 14, wherein each voxel comprises a plurality of feature vectors comprising information relating to a region of the scene.

17. The non-transitory computer readable storage medium of claim 16, wherein the information comprises at least one of a signed distance field (SDF), a density, or a color value corresponding to the region.

18. The non-transitory computer readable storage medium of claim 16, wherein the executable further causes the processor to initialize the feature vectors randomly with a Gaussian distribution.

19. The non-transitory computer readable storage medium of claim 14, wherein the executable further causes the processor to generate a representation of the scene using a neural radiance field (NeRF) technique.

20. The non-transitory computer readable storage medium of claim 14, wherein the first neural network comprises a signed distance field (SDF) neural network and the second neural network comprises a shading neural network.
